(19) United States
(12) Patent Application Publication
(10) Pub. No.: US 2025/0207783 A1
(43) Pub. Date: Jun. 26, 2025

(54) INDUCTION COOKING APPLIANCE AND METHOD

(71) Applicant: WHIRLPOOL CORPORATION, BENTON HARBOR, MI (US)

(72) Inventors: ANDREA GALLIVANONI, CASORATE SEMPIONE (IT); DANIELE MASI, TRAVEDONA (IT); GIAN MAURO MUSSO, PORTOGRUARO (IT); COLLIN A. STIPE, WEST UNITY, OH (US)

(21) Appl. No.: 18/390,402

(22) Filed: Dec. 20, 2023

(51) Int. Cl. F24C 15/10; H05B 6/06

(52) U.S. Cl. CPC F24C 15/105; H05B 6/065; H05B 2213/07

(57) ABSTRACT

A method of controlling an induction cooking appliance having a cook surface and an induction coil, and with a cooking vessel disposed on the cook surface, includes sensing a cook-surface temperature during operation of an induction coil, sensing a thermal power delivered to the cooking vessel, and transmitting the cook-surface temperature and the thermal power to a controller module comprising a parameter set and a temperature module.

### TECHNICAL FIELD

The description generally relates to induction cooking appliances, and more specifically a controllable induction cooking appliance with a temperature module.

### BACKGROUND

Cooking appliances, such as cooktops, ranges, etc., have cook surfaces with hobs that generate heat for cooking or warming food items in a cooking vessel. Traditional cooking appliances provide thermal energy to the hob, such as by a gas fuel or electricity, which is conductively transferred to a cooking vessel placed thereon. In other examples, induction cooking appliances provide energy directly to the cooking vessel by way of electromagnetic induction using a variable-current coil and a suitable metallic cooking vessel. During operation, such induction cooking appliances can have much cooler surface temperatures compared to traditional cooking appliances with conductive hobs or burners.

Induction cooking appliances can also be controlled based on a sensed system parameter. For instance, U.S. Pat. No. 8,530,805 discloses a method for controlling an induction heating system including a computing model estimating a pan temperature by way of a sensed current. In another example, U.S. Pat. No. 8,563,905 discloses a method for controlling an induction heating system including a computing model estimating a pan temperature by way of a sensed component temperature and an assessed power value.

### BRIEF SUMMARY

In one aspect, the disclosure relates to a method of controlling an induction cooking appliance having a cook surface and an induction coil, and with a cooking vessel disposed on the cook surface. The method comprises sensing a cook-surface temperature during operation of the induction coil; determining a thermal power delivered to the cooking vessel; transmitting the cook-surface temperature and the thermal power to a controller module having a parameter set and a temperature module having a thermodynamic model of the cook surface, the cooking vessel, and ambient air; determining, by the temperature module, an estimated vessel temperature of the cooking vessel based on the thermodynamic model, the cook-surface temperature, and the thermal power; comparing the estimated vessel temperature with a temperature set point for the induction cooking appliance; and controllably operating the induction cooking appliance based on the comparison.

In another aspect, the disclosure relates to an induction cooking appliance, comprising a cook surface with a heating zone configured to receive a cooking vessel; an induction heating system having an induction coil and a power supply and configured to generate heat within the cooking vessel by electromagnetic induction; a temperature sensor coupled to the cook surface and configured to provide a signal indicative of a cook-surface temperature; a power sensor configured to provide a signal indicative of an electrical power delivered to the induction coil, with the electrical power corresponding to a thermal power delivered to the cooking vessel; a controller module coupled to the temperature sensor and the sensor, and operably coupled to the induction heating system, the controller module comprising a parameter set and a temperature module having a thermodynamic model of the cook surface, the cooking vessel, and ambient air; wherein the controller module is configured to: determine, via the temperature module, an estimated vessel temperature based on the thermodynamic model, the cook-surface temperature, and the thermal power; compare the estimated vessel temperature with a temperature set point for the induction cooking appliance; and controllably operate the induction cooking appliance based on the comparison.

### BRIEF DESCRIPTION OF THE DRAWINGS

In the drawings:

FIG. 1 is a perspective schematic view of an induction cooking appliance and a cooking vessel in accordance with various aspects described herein.

FIG. 2 is a schematic cross-sectional view of the induction cooking appliance and cooking vessel of FIG. 1 and illustrating a controller module in accordance with various aspects described herein.

FIG. 3 is a schematic cross-sectional view of the induction cooking appliance and cooking vessel of FIG. 2 and illustrating heat transfer mechanisms during operation.

FIG. 4 is a block diagram of the induction cooking appliance and cooking vessel of FIG. 1 and illustrating a temperature module in accordance with various aspects described herein.

FIG. 5 is a flowchart illustrating a method of operating an induction cooking appliance in accordance with various aspects described herein.

### DETAILED DESCRIPTION

Cooking appliances can include one or more sensors and one or more controllers for automatic control of a cycle of operation. For instance, in traditional cooking appliances with a hob utilizing gas or electric heat, a user may select a particular heat setting for the hob, e.g., “medium,” “power level 8,” or the like, for cooking a food item for a predetermined amount of time. However, a particular heat setting or power setting for a hob may not be the same as a cooking vessel temperature, or of a temperature of a cooking cavity within the cooking vessel, due to waste heat, user-interface specificity (e.g., knob sensitivity), or other effects. Inaccuracies of cooking vessel temperatures can lead to undesirable outcomes such as unpredictable cooking times or overcooking or undercooking of food items.

Induction cooking appliances can include controller modules providing estimates of component temperatures, such as pan temperatures, which may be difficult to directly sense or measure during use. However, such induction cooking appliances are typically calibrated for use with a limited set of cooking vessels and may not provide an accurate temperature estimate in the event that a different cooking vessel outside the calibrated set is used with the cooking appliance.

Aspects of the disclosure provide for an induction cooking appliance and control method used for estimating a cooking vessel temperature during use, by way of a hidden state observer and a thermodynamic model of thermal exchanges between the cooking vessel, cook surface, and ambient air. The induction cooking appliance and control method described herein can be used with a wide range of cooking vessels, including cooking vessels that have not previously been used, tested, or the like with the disclosed induction cooking appliance.

Features, advantages, and aspects of the present disclosure are set forth or apparent from a consideration of the following detailed description, drawings, and claims. Moreover, the following detailed description is exemplary and intended to provide explanation without limiting the scope of the disclosure as claimed.

As used herein, the terms “first,” “second,” “third,” “fourth,” or the like can be used interchangeably to distinguish one component from another and are not intended to signify location or importance of the individual components. In addition, the singular forms “a,” “an,” and “the” include plural references unless the context clearly dictates otherwise.

Also, as used herein, while sensors can be described as “sensing” or “measuring” a respective value, sensing or measuring can include determining a value indicative of or related to the respective value, rather than directly sensing or measuring the value itself. The sensed or measured values can further be provided to additional components. For instance, the value can be provided to a controller module or processor, and the controller module or processor can perform processing on the value to determine a representative value or an electrical characteristic representative of said value.

Additionally, while terms such as “voltage”, “current”, and “power” can be used herein, it will be evident to one skilled in the art that these terms can be interrelated when describing aspects of the electrical circuit, or circuit operations.

Additionally, as used herein, a “controller” or “controller module” can include a component configured or adapted to provide instruction, control, operation, or any form of communication for operable components to effect the operation thereof. A controller module can include any known processor, microcontroller, or logic device, including, but not limited to: field programmable gate arrays (FPGA), an application specific integrated circuit (ASIC), a proportional controller (P), a proportional integral controller (PI), a proportional derivative controller (PD), a proportional integral derivative controller (PID controller), a hardware-accelerated logic controller (e.g. for encoding, decoding, transcoding, etc.), or the like, or a combination thereof. Non-limiting examples of a controller module can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types.

Such a controller module as described herein may also compare a first value with a second value and may operate or control operations of additional components based on the satisfaction of that comparison. As used herein, the term “satisfies” or “satisfaction” of a comparison between a first value and a second value will refer to a determination of whether the first value exceeds the second value, or does not exceed the second value, or is equal to the second value, such that the comparison is “true” when satisfied. In addition, as used herein, the term “satisfies” or “satisfaction” of a comparison between a first value and a value range refers to a determination that the first value is within the value range, such that the comparison is “true” when satisfied. It will be understood that such a determination may easily be altered to be satisfied by a positive/negative comparison or a true/false comparison. Example comparisons can include comparing a sensed or measured value to a threshold value, or to a threshold value range. For example, when a sensed, measured, or provided value is compared with another value or range, including a stored or predetermined value or range, the satisfaction of that comparison can result in actions, functions, or operations controllable by the controller module.

Such a controller module as described herein can further include a data storage component accessible by the processor, including memory, whether transient, non-transient, volatile, or non-volatile memory. Machine-executable instructions, associated data structures, and program modules represent examples of program code for executing methods disclosed herein. Machine-executable instructions can include, for example, instructions and data, which cause a general purpose computer, special purpose computer, or special purpose processing machine to perform a certain function or group of functions.

Additional non-limiting examples of the memory can include Random Access Memory (RAM), Read-Only Memory (ROM), flash memory, or one or more different types of portable electronic memory, such as discs, DVDs, CD-ROMs, flash drives, universal serial bus (USB) drives, the like, or any suitable combination of these types of memory. In one example, the program code can be stored within the memory in a machine-readable format accessible by the processor. Additionally, the memory can store various data, data types, sensed or measured data values, inputs, generated or processed data, or the like, accessible by the processor in providing instruction, control, or operation to effect a functional or operable outcome, as described herein.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, secured, fastened, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

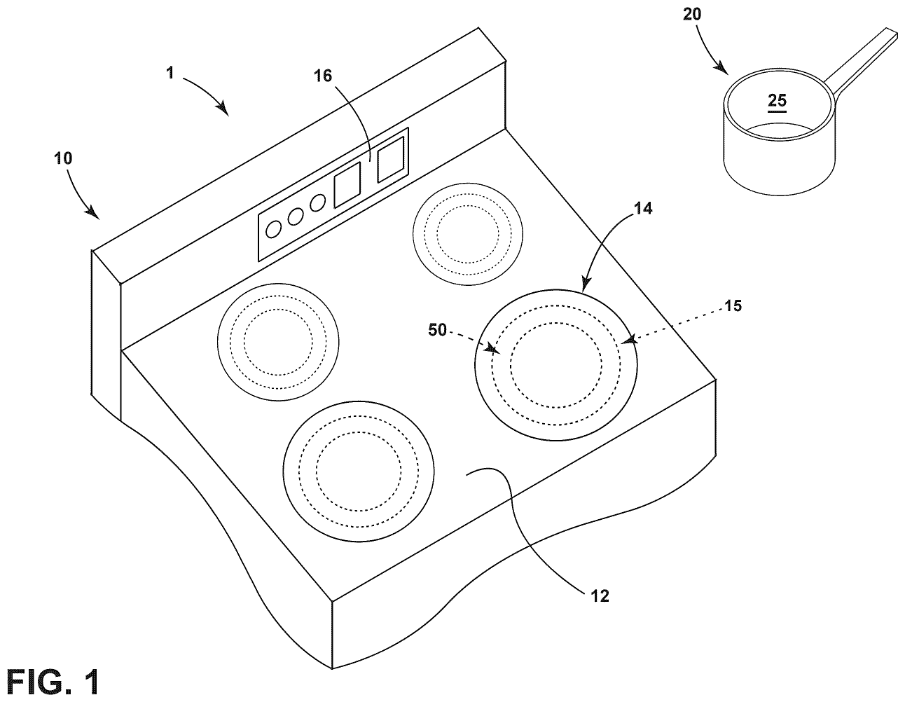

Turning to FIG. 1, an exemplary induction cooking system 1 includes an induction cooking appliance 10 (also referred to herein as “cooking appliance 10”) and a cooking vessel 20. The cooking appliance 10 includes a cook surface 12 that can define at least one heating zone 14 for heating the cooking vessel 20. While a single heating zone 14 is illustrated in FIG. 1, the cooking appliance 10 can include multiple heating zones 14 accommodating multiple cooking vessels 20. In addition, the cooking vessel 20 defines a cooking cavity 25 for receiving food items. In the illustrated example the cooking vessel 20 is shown as a saucepan, however the cooking vessel 20 can have any suitable form such as a frying pan, a sheet pan, a bowl, or the like.

An induction heating system 50 is provided and configured to generate heat within the cooking vessel 20 when positioned over the heating zone 14. The induction heating system 50 includes an induction coil 15 positioned beneath the cook surface 12. Additionally, the cook surface 12 can include a material with a low electrical conductivity or a low thermal conductivity, such as glass or glass-ceramic in some examples. The cooking vessel 20 can include any suitable material for warming by electromagnetic induction, including ferromagnetic materials such as iron. In this manner, the cooking vessel 20 can be directly heated during operation of the induction coil 15.

The cooking appliance 10 can further include a user interface 16. The user interface 16 can be used by a user to control operation of the cooking appliance 10, including setting a cooking mode, setting a cooking temperature, or setting a timer, in some examples. The user interface 16 can include any suitable interface elements such as buttons, knobs, toggles, display screens, touch screens, light sources, or audio sources, in some examples. As shown, the user interface 16 is located on the cooking appliance 10 though this need not be the case. In some implementations, the user interface 16 can be located on a separate device, such as a mobile device, a tablet, or a central hub in some non-limiting examples. It is also contemplated that the user interface 16 can include user-interactive elements on the cooking appliance 10 and additional user-interactive elements on a separate device.

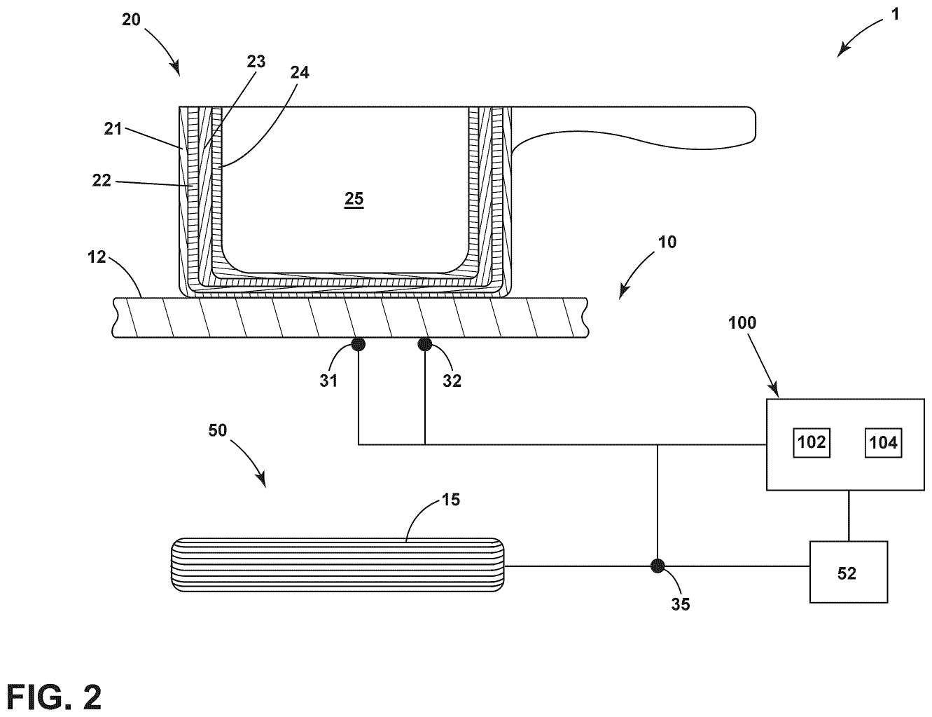

Turning to FIG. 2, a side cross-sectional view illustrates the cooking vessel 20 positioned on the cook surface 12. The induction coil 15 is schematically illustrated with wide spacing from the cook surface 12 for visual clarity, and it will be understood that the induction coil 15 can be positioned directly adjacent the cook surface 12 or with a small gap therebetween.

The cooking vessel 20 is illustrated as having multiple stacked material layers. It will be understood that the cooking vessel 20 can include any number of layers, including only one. For instance, in some implementations, the cooking vessel 20 can have a body formed with a single material or alloy throughout.

In the exemplary implementation shown, the cooking vessel 20 includes a first layer 21, a second layer 22, a third layer 23, and a fourth layer 24. The first layer 21 defines a bottom of the cooking vessel 20 and can include a magnetic material such as magnetic steel. The second layer 22 can include aluminum, such as cast aluminum or hardened aluminum in some examples. The third layer 23 can include steel, such as magnetic steel or non-magnetic steel. The fourth layer 24 can include a non-stick material or coating, such as polytetrafluoroethylene (PTFE) or ceramic. In some implementations, the third layer 23 can be omitted and the cooking vessel 20 can be provided with a non-stick coating over the second layer 22. It is further contemplated that any of the layers 21-24 can extend over predetermined portions of the cooking vessel 20. For instance, in some implementations the first layer 21 can be provided or applied to the bottom of the cooking vessel 20 without extending up a sidewall. In this manner, the cooking vessel 20 may include a magnetic layer over a bottom portion only.

The induction heating system 50 further includes a power supply 52 electrically coupled to the induction coil 15. The power supply 52 can provide any suitable power, including alternating-current (AC) power or direct-current (DC) power. In some implementations, other components such as power converters, transformers, or the like can also be provided and configured to modify or adjust a power characteristic for the power supply 52.

A controller module 100 (also referred to herein as “controller 100”) is also provided for operating the cooking appliance 10. For instance, the controller 100 can operate the cooking appliance 10 via input from a user received at the user interface 16, such as for selecting a cycle of operation and controlling the operation of the cooking appliance 10 to implement the selected cycle of operation. It is also contemplated that the controller 100 can include machine-readable instructions for partially or fully automating operation of the cooking appliance 10 without direct control from the user. Further still, in some implementations the controller 100 can be in signal communication with a local network or an external network, including by way of a wired connection or a wireless connection.

The controller 100 can be provided with at least a processor 102, such as a central processing unit (CPU), and a memory 104, for controlling and operating the cooking appliance 10. The memory 104 can be used for storing, for example, control software that is executed by the processor 102 in completing a cycle of operation using the cooking appliance 10. The memory 104 can also be used to store information, such as a database or table, and to store data received from the one or more components of the cooking appliance 10 that can be communicably coupled with the controller 100. The database or table can be used to store the various operating parameters for the cooking appliance 10, including factory default values for operating parameters and any adjustments to the factory default values by the control system or by user input. Additionally, it is contemplated that the memory 104 can store common settings, recipes, or other preferences common to the user, or any information.

The controller 100 can be communicably and operably coupled with one or more components of the cooking appliance 10 for communicating with and controlling the operation of the component to complete a cycle of operation. Such a cycle of operation can include, but is not limited to, a cooking cycle, a baking cycle, a bread-proofing cycle, a defrost cycle, or a warming cycle. More specifically, the controller 100 can be operably coupled to the power supply 52 for controlling the power output to the induction coil 15. The controller 100 can also be operably coupled with the user interface 16 for receiving user-selected inputs and communicating information to the user. For example, a user may select a temperature set point at which the user desires the temperature of the cooking vessel 20 to reach, or a cycle of operation which includes one or more temperature set points. Furthermore, the controller 100 can receive input from one or more sensors. In the implementation shown, a first temperature sensor 31 and a second temperature sensor 32 are provided, with the first temperature sensor 31 positioned centrally within the heating zone 14 and the second temperature sensor 32 positioned adjacent an edge of the heating zone 14. Any number or arrangement of temperature sensors can be utilized. In addition, a power sensor 35 is provided and configured to provide a signal indicative of electric power delivered to the induction coil 15. It will be understood that the electric power delivered to the induction coil 15 substantially corresponds to a thermal power delivered to the cooking vessel 20. For instance, the thermal power delivered to the cooking vessel 20 can be between 70-100% of the electric power delivered to the induction coil 15, including between 80-100% of the electric power, including between 90-100% of the electric power, including between 95-100% of the electric power. The power sensor 35 can be configured to sense or detect a current circulating through the induction coil 15 in some implementations, or to sense or detect the electrical power directly in some implementations. It is understood that the circulating current correlates to the electrical power delivered to the induction coil 15. Furthermore, additional sensors can be provided for separate sensing or measuring of current within the induction coil 15, voltage across the induction coil 15, or electrical power delivered to the induction coil 15, in non-limiting examples.

Such sensor input from the first temperature sensor 31, the second temperature sensor 32, or the power sensor 35 can be used by the controller 100 to controllably operate the induction cooking appliance 10, such as setting or modifying a cooking time, or a power supply to the induction coil 15, or a temperature of the cooking vessel 20, in non-limiting examples.

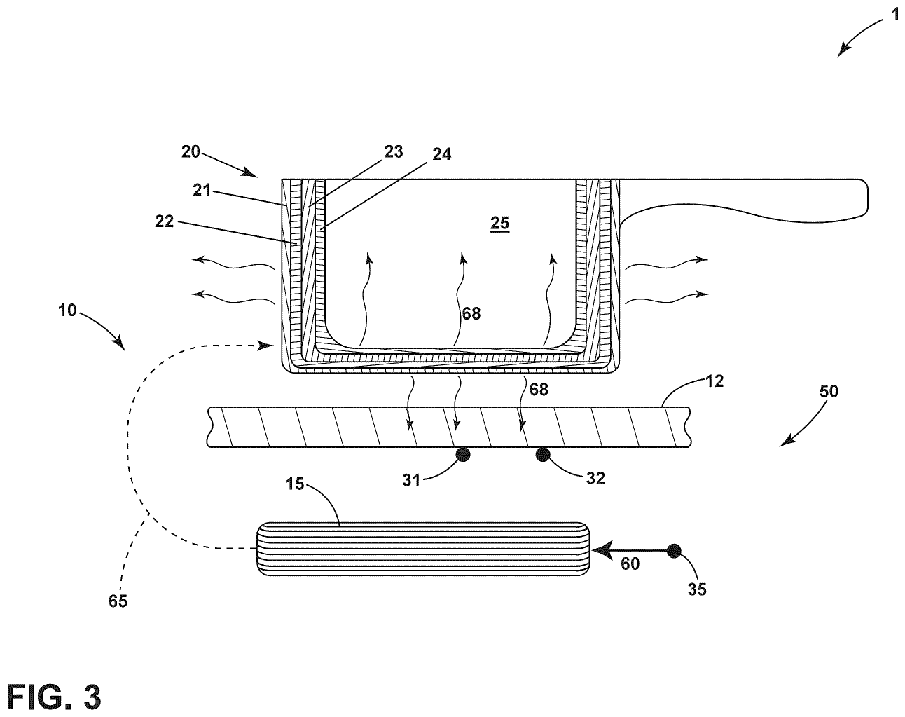

FIG. 3 illustrates some exemplary energy transfers between portions of the cooking appliance 10 and the cooking vessel 20 during operation. The cooking vessel 20, the cook surface 12, and the induction coil 15 are illustrated with exaggerated spacing distances for visual clarity.

A coil power 60 (shown with an arrow) represents the electric power delivered to the induction coil 15 by the power supply 52 (FIG. 2). A dashed arrow represents inductive heat 65 produced in the cooking vessel 20 by way of a time-varying electromagnetic field produced by the induction coil 15. Wavy arrows represent vessel heat 68 that is transferred from the cooking vessel 20 to the surrounding environment. For instance, portions of the vessel heat 68 can be conductively transferred to food items within the cooking cavity 25, conductively transferred to the cook surface 12, or convectively or radiatively transferred to the surrounding air, in non-limiting examples. In this manner, the cooking vessel 20 can be directly heated by induction via the induction coil 15, and the cook surface 12 can be indirectly heated by way of conduction from the cooking vessel 20, resulting in lower temperatures of the cook surface 12 compared to traditional cooktops.

It should be understood that the energy transfers shown in FIG. 3 are exemplary, and that other energy transfers may also be present between components of the induction cooking appliance 10 or the cooking vessel 20. For instance, the induction coil 15 can undergo Joule heating during operation, which can lead to additional warming of the cook surface 12, or of ambient air below the cook surface 12, in non-limiting examples.

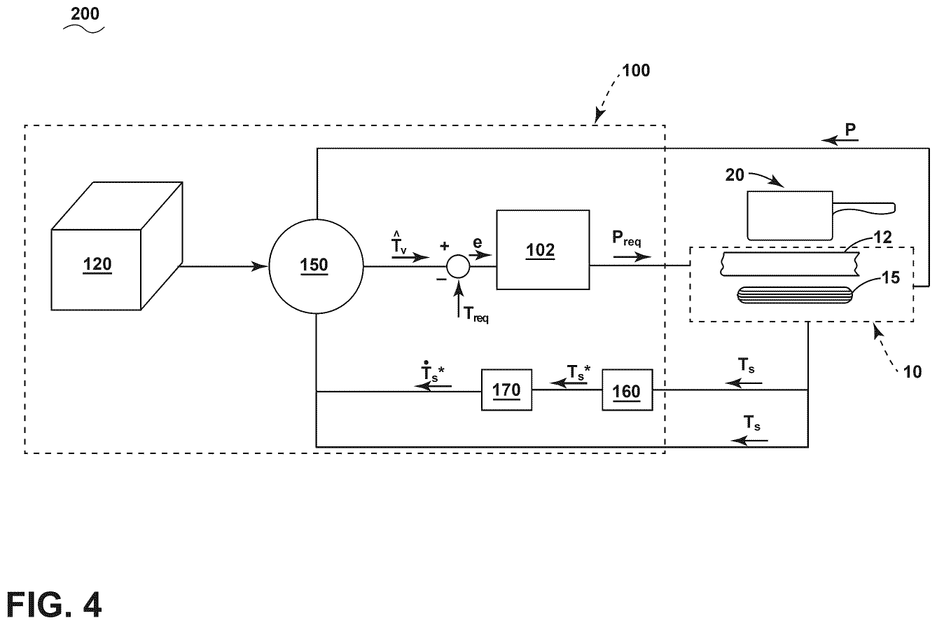

Referring now to FIG. 4, a block diagram 200 is illustrated during operation of the induction cooking appliance 10. Dashed lines are used to schematically indicate the controller module 100 and the induction cooking appliance 10 used with the cooking vessel 20.

The controller module 100 can include the processor 102, which can include a proportional-integral (PI) controller in some examples. The controller module 100 can include a parameter set 120 having one or more vessel parameters representative of a physical or thermal property of one or more cooking vessels that may be used with the induction cooking appliance 10. The controller module 100 can also include a temperature module 150 having a thermodynamic model of the cook surface 12, the cooking vessel 20, and ambient air above and/or below the cook surface. In addition, the controller module 100 can optionally include a low-pass filter 160 and a numerical differentiator 170, such as a Holo filter in one example.

During operation, the temperature module 150 can receive the parameter set 120 as well as a thermal power P, based on signals from the power sensor 35 indicative of the coil power 60, and also a temperature signal representative of a measured temperature of the cook surface 12, based on sensor signals from either or both of the first temperature sensor 31 or the second temperature sensor 32. In particular, the illustrated example shows that a sensed cook-surface temperature Tₛ can be passed or transmitted to the low-pass filter 160 to define a filtered cook-surface temperature Tₛ*, which is passed to the numerical differentiator 170. The numerical differentiator 170 can determine a rate of change of the filtered cook-surface temperature \dot{T}ₛ*. Either or both of the filtered cook-surface temperature Tₛ* or the rate of change \dot{T}ₛ* thereof can be passed to the temperature module 150. Furthermore, in some implementations the sensed cook-surface temperature Tₛ can be transmitted directly to the temperature module 150 without filtering.

The temperature module 150 can be configured to determine an estimated vessel temperature \hat{T}ᵥ based on the parameter set 120, the thermodynamic model, the cook-surface temperature Tₛ, and the thermal power P. For instance, the parameter set 120 can include a thermal exchange coefficient γᵥₛ between the cooking vessel 20 and the cook surface 12, a thermal exchange coefficient γᵥₐ between the cooking vessel 20 and ambient air, a thermal capacity Cᵥ of the cooking vessel 20, a thermal capacity Cₛ of the cook surface 12, a convergence rate, a power transfer efficiency, or the like.

It is contemplated that values in the parameter set 120 can be identified, selected, or the like to represent a wide range of cooking vessels. For instance, one or more data acquisition tests can be performed on a plurality of known cooking vessels, where the plurality of known cooking vessels defines a representative sample for all suitable cooking vessels that may be utilized with the induction cooking appliance 10. Such tests can include one or multiple temperature setpoints and can also include closed-loop temperature data acquisition or open-loop power data acquisition in some examples. Based on the data acquisition tests, a plurality of known parameter sets can be determined wherein each known cooking vessel in the plurality of known cooking vessels corresponds to one known parameter set in the plurality of known parameter sets. In this manner, the plurality of known parameter sets can define individual models (see Expression 1 above) representing the induction cooking appliance 10 and all known cooking vessels in the plurality of known cooking vessels. Operation of the controller module 100 can be simulated in a virtual environment using the temperature module 150 and the plurality of known parameter sets. Such simulation results can then be evaluated, analyzed, optimized, or the like to determine values for the parameter set 120, which defines a representative parameter set for thermal exchanges between the induction cooking appliance 10 and any suitable cooking vessel that may be used therewith. Such a cooking vessel need not be included in the plurality of known cooking vessels. It is contemplated, for instance, that the plurality of known cooking vessels does not include the illustrated cooking vessel 20. In this manner, a particular cooking vessel need not be measured or calibrated prior to use with the induction cooking appliance 10.

Moreover, as the cooking vessel 20 may not be provided with a separate thermometer or temperature sensor, it is understood that the estimated vessel temperature \hat{T}ᵥ represents a hidden parameter. The temperature module 150 can include a block or module configured to determine an estimate for hidden parameters, such as a hidden-state observer or a Kalman filter in some examples.

In one exemplary implementation, the temperature module 150 can include a hidden-state observer, such as a state observer as described by Isidori (see Nonlinear Control Systems, Springer (1995)). The state observer can be based on a thermodynamic model including a set of differential equations as shown in Expression (2) below:

$$[ \begin{matrix}{\dot{\hat{T}}}_{v} \\ {\dot{\hat{T}}}_{s}\end{matrix} ] = [ \begin{matrix}{a}_{11} & {a}_{12} \\ {a}_{21} & {a}_{22}\end{matrix} ] [ \begin{matrix}\hat{{T}_{v}} \\ {\hat{T}}_{s}\end{matrix} ] + [ \begin{matrix}{b}_{11} & {b}_{12} & {b}_{13} \\ {b}_{21} & {b}_{22} & {b}_{23}\end{matrix} ] [ \begin{matrix}P \\ {T}_{s} \\ {\dot{T}}_{s}\end{matrix} ] \qquad ( 2 )$$

where:
a₁₁ . . . a₂₂ and b₁₁ . . . b₂₃ are coefficients, which can include suitable values from the parameter set 120 as described above;
P is the thermal power delivered to the cooking vessel 20, which can represent an instantaneous thermal power in some examples;
Tₛ is the cook-surface temperature, which can be based on signals from either or both of the first temperature sensor 31 or the second temperature sensor 32;
\hat{T}ₛ is an estimated cook-surface temperature, which can be based on signals from the first temperature sensor 31, the second temperature sensor 32, the power sensor 35, or combinations thereof;
\dot{T}ₛ is a measured rate of change for the cook-surface temperature;
\dot{\hat{T}}ₛ is an estimated rate of change for the cook-surface temperature;
\hat{T}ᵥ is the estimated vessel temperature, as determined by the temperature module 150; and
\dot{\hat{T}}ᵥ is an estimated rate of change of the vessel temperature.

It is contemplated that the measured rate of change \dot{T}ₛ can be determined from sampled temperature data from the first or second temperature sensors 31, 32 by way of the numerical differentiator 170. In this manner, the controller module 100 can be configured to determine the estimated vessel temperature \hat{T}ᵥ for the cooking vessel 20 during operation.

In another implementation, the temperature module 150 can include another hidden-state observer, such as an Isidori state observer, based on another thermodynamic model having another set of differential equations as shown in Expression (3) below:

$$[ \begin{matrix}{\dot{\hat{T}}}_{v} \\ {\dot{\hat{T}}}_{s} \\ {\dot{\hat{T}}}_{i n t}\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}{\hat{T}}_{v} \\ {\hat{T}}_{s} \\ {\hat{T}}_{i n t}\end{matrix} ] + [ \begin{matrix}{b}_{11} & {b}_{12} & {b}_{13} & {b}_{14} \\ {b}_{21} & {b}_{22} & {b}_{23} & {b}_{24} \\ {b}_{31} & {b}_{32} & {b}_{33} & {b}_{34}\end{matrix} ] [ \begin{matrix}P \\ {T}_{s} \\ {\dot{T}}_{s} \\ {\hat{T}}_{i n t}\end{matrix} ] \qquad ( 3 )$$

where:
a₁₁ . . . a₃₃ and b₁₁ . . . b₃₄ are coefficients, which can include suitable values from the parameter set 120 as described above;
P is the thermal power delivered to the cooking vessel 20, which can represent an instantaneous thermal power in some examples;
\hat{T}ᵢₙₜ is an estimated temperature of the ambient air beneath the cook surface 12;
\dot{\hat{T}}ᵢₙₜ is an estimated rate of change for the temperature of the ambient air beneath the cook surface 12;
Tₛ is the cook-surface temperature, which can be based on signals from either or both of the first temperature sensor 31 or the second temperature sensor 32;
\hat{T}ₛ is an estimated cook-surface temperature, which can be based on signals from the first temperature sensor 31, the second temperature sensor 32, the power sensor 35, or combinations thereof;
\dot{T}ₛ is a measured rate of change for the cook-surface temperature;
\dot{\hat{T}}ₛ is an estimated rate of change for the cook-surface temperature;
\hat{T}ᵥ is the estimated vessel temperature, as determined by the temperature module 150; and
\dot{\hat{T}}ᵥ is an estimated rate of change of the vessel temperature.

In this manner, the controller module 100 can be further configured to estimate an ambient air temperature beneath the cook surface 12 to account for localized air heating within the induction cooking appliance 10, thereby providing for improved accuracy in the estimated vessel temperature \hat{T}ᵥ. For instance, the induction coil 15 can increase in temperature due to resistive heating during operation, which can cause localized warming in the air environment within the induction cooking appliance 10. It is contemplated that the ambient air temperature \hat{T}ᵢₙₜ beneath the cook surface 12 can be estimated as a function of either or both of the coil power 60 delivered to the induction coil 15 (FIG. 3) or the current circulating through the induction coil 15.

In still another implementation, the numerical differentiator 170 can be omitted from the controller module 100, such as to reduce noise in the control loop. In such a case, the temperature module 150 can include a derivative-less Isidori state observer. Particularly, by the following substitution as shown in Expression (4) below:

$$ξ = {\dot{\hat{T}}}_{v} - N {T}_{s} \qquad ( 4 )$$

the temperature module 150 can include another thermodynamic model with another set of differential equations as shown in Expression (5) below:

$$\{ \begin{matrix}\dot{ξ} = ( {a}_{11} - {Na}_{21} ) ξ + ( {a}_{12} - {Na}_{22} + {N}_{11} - {N}^{2} {a}_{21} ) {T}_{s} + {b}_{1} P \\ {\hat{T}}_{v} = ξ + N {T}_{s}\end{matrix} \qquad ( 5 )$$

where:
a₁₁ . . . a₂₂ and b₁ are coefficients, which can include suitable values from the parameter set 120 as described above;
P is the thermal power delivered to the cooking vessel 20, which can represent an instantaneous thermal power in some examples;
Tₛ is the cook-surface temperature based on signals from either or both of the first temperature sensor 31 or the second temperature sensor 32;
\hat{T}ᵥ is the estimated vessel temperature, as determined by the temperature module 150;
\dot{\hat{T}}ᵥ is an estimated rate of change of the vessel temperature; and
N is a convergence rate.

It will also be understood that Expression (5) can be implemented as a system of equations, as described above.

Regardless of which set of expressions is utilized for the temperature module 150, the exemplary control block 200 illustrates that the temperature module 150 can determine the estimated vessel temperature \hat{T}ᵥ based on thermodynamic modeling. The controller 100 can additionally perform a comparison of the estimated vessel temperature \hat{T}ᵥ with a temperature set point T_{req} for the cooking vessel 20. The temperature set point T_{req} can include or represent a selected power setting or temperature setting on the user interface 16 (FIG. 1), or an automatic power setting or temperature setting as determined by the controller module 100, or a power setting or temperature setting based on a recipe or cooking instruction, in some examples. For instance, a user may select a temperature set point of 120° C. by way of the user interface 16, and the controller module 100 can compare the user-selected temperature set point T_{req} with the estimated vessel temperature \hat{T}ᵥ.

Further still, the processor 102 can also determine a difference or error e based on the comparison as shown. It is also contemplated that the processor 102 can controllably operate the induction cooking appliance 10, including the induction heating system 50, based on the error e. For instance, in one non-limiting example of operation, a user may select a temperature set point T_{req} of 105° C. by way of the user interface. During operation, the controller module 100 can determine an estimated vessel temperature \hat{T}ᵥ and compare with the temperature set point T_{req}. Based on the comparison, including based on the error e, the processor 102 can define a requested power level P_{req} for the induction coil 15. In this manner, the controller 100 can be configured to controllably operate the induction cooking appliance 10 based on the comparison.

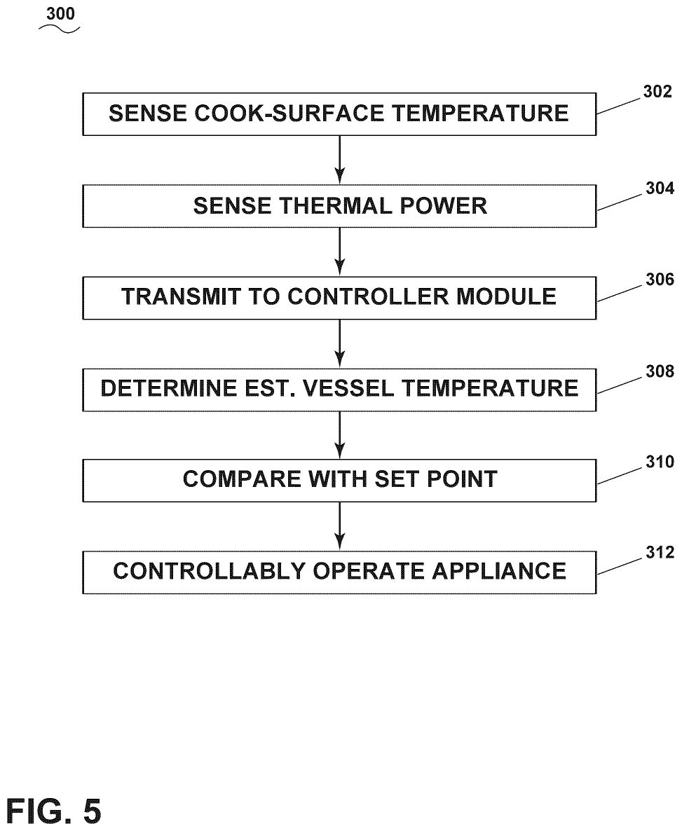

Referring now to FIG. 5, a method 300 is illustrated for controlling the induction cooking appliance 10. The method 300 includes at 302 sensing a cook-surface temperature during operation of the induction coil 15. The method 300 includes at 304 determining a thermal power delivered to the cooking vessel 20, such as by way of the power sensor 35. The method 300 also includes at 306 transmitting the cook-surface temperature and the thermal power to a controller module, such as the controller module 100, having a parameter set and a temperature module having a thermodynamic model of the cook surface, the cooking vessel, and ambient air. The method 300 further includes at 308 determining, by the temperature module 150, an estimated vessel temperature of the cooking vessel 20 based on the thermodynamic model, the cook-surface temperature, and the thermal power as described above. The method 300 also includes at 310 comparing the estimated vessel temperature with a temperature set point for the induction cooking appliance. The method 300 further includes at 312 controllably operating the induction cooking appliance based on the comparison.

Aspects of the present disclosure described herein provide for an induction cooking appliance and method with an improved temperature estimation performance compared to traditional induction cooktops. Aspects of the disclosure further provide for controllable temperature operation having broad compatibility with available cooking vessels, pans, griddles, and the like, without need of individual calibration or external temperature probes.

To the extent not already described, the different features and structures of the various aspects can be used in combination with each other as desired. That one feature is not illustrated in all of the aspects is not meant to be construed that it cannot be, but is done for brevity of description. Thus, the various features of the different aspects can be mixed and matched as desired to form new aspects, whether or not the new aspects are expressly described.

This written description uses examples to disclose aspects of the disclosure, including the best mode, and also to enable any person skilled in the art to practice aspects of the disclosure, including making and using any devices or systems and performing any incorporated methods. While aspects of the disclosure have been specifically described in connection with certain specific details thereof, it is to be understood that this is by way of illustration and not of limitation. Reasonable variation and modification are possible within the scope of the forgoing disclosure and drawings without departing from the spirit of the disclosure, which is defined in the appended claims.

Further aspects of the disclosure are provided by the subject matter of the following clauses:

A method of controlling an induction cooking appliance having a cook surface and an induction coil, and with a cooking vessel disposed on the cook surface, the method comprising: sensing a cook-surface temperature during operation of the induction coil; determining a thermal power delivered to the cooking vessel; transmitting the cook-surface temperature and the thermal power to a controller module comprising a parameter set having one or more vessel parameters, and also comprising a temperature module having a thermodynamic model of the cook surface, the cooking vessel, and ambient air; determining, by the temperature module, an estimated vessel temperature of the cooking vessel based on the thermodynamic model, the cook-surface temperature, and the thermal power; comparing the estimated vessel temperature with a temperature set point for the cooking vessel; and controllably operating the induction cooking appliance based on the comparison.

The method of any preceding clause, wherein the parameter set comprises at least one of a thermal exchange coefficient γᵥₛ representative of thermal exchange between the cooking vessel and the cook surface, a thermal exchange coefficient γᵥₐ representative of thermal exchange between the cooking vessel and ambient air present above and below the cook surface, a thermal capacity Cᵥ representative of the cooking vessel, a thermal capacity Cₛ representative of the cook surface, a convergence rate, or a power transfer efficiency.

The method of any preceding clause, wherein the temperature module comprises a hidden-state observer with a set of differential equations as:

$$[ \begin{matrix}{\dot{\hat{T}}}_{v} \\ {\dot{\hat{T}}}_{s}\end{matrix} ] = [ \begin{matrix}{a}_{11} & {a}_{12} \\ {a}_{21} & {a}_{22}\end{matrix} ] [ \begin{matrix}{\hat{T}}_{v} \\ {\hat{T}}_{s}\end{matrix} ] + [ \begin{matrix}{b}_{11} & {b}_{12} & {b}_{13} \\ {b}_{21} & {b}_{22} & {b}_{23}\end{matrix} ] [ \begin{matrix}P \\ {T}_{s} \\ {\dot{T}}_{s}\end{matrix} ]$$

where: a₁₁ . . . a₂₂ and b₁₁ . . . b₂₃ are coefficients including at least one value from the parameter set; P is the thermal power; Tₛ is the cook-surface temperature; \dot{T}ₛ is a measured rate of change for the cook-surface temperature; \dot{\hat{T}}ₛ is an estimated rate of change for the cook-surface temperature; \hat{T}ᵥ is the estimated vessel temperature; and \dot{\hat{T}}ᵥ is an estimated rate of change of the vessel temperature.

The method any preceding clause, wherein the temperature module comprises a hidden-state observer with a set of differential equations as:

$$[ \begin{matrix}{\dot{\hat{T}}}_{v} \\ {\dot{\hat{T}}}_{s} \\ {\dot{\hat{T}}}_{i n t}\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}{\hat{T}}_{v} \\ {\hat{T}}_{s} \\ {\hat{T}}_{i n t}\end{matrix} ] + [ \begin{matrix}{b}_{11} & {b}_{12} & {b}_{13} & {b}_{14} \\ {b}_{21} & {b}_{22} & {b}_{23} & {b}_{24} \\ {b}_{31} & {b}_{32} & {b}_{33} & {b}_{34}\end{matrix} ] [ \begin{matrix}P \\ {T}_{s} \\ {\dot{T}}_{s} \\ {\hat{T}}_{i n t}\end{matrix} ]$$

where: a₁₁ . . . a₃₃ and b₁₁ . . . b₃₄ are coefficients including at least one value from the parameter set; P is the thermal power delivered to the cooking vessel 20; \hat{T}ᵢₙₜ is an estimated temperature of the ambient air beneath the cook surface 12; \dot{\hat{T}}ᵢₙₜ is an estimated rate of change for the temperature of the ambient air beneath the cook surface 12; Tₛ is the cook-surface temperature; \hat{T}ₛ is an estimated cook-surface temperature based on signals from at least one of the first temperature sensor 31, the second temperature sensor 32, or the power sensor 35; \dot{T}ₛ is a measured rate of change for the cook-surface temperature; \dot{\hat{T}}ₛ is an estimated rate of change for the cook-surface temperature; \hat{T}ᵥ is the estimated vessel temperature; and \dot{\hat{T}}ᵥ is an estimated rate of change of the vessel temperature.

The method of any preceding clause, wherein the temperature module comprises a hidden-state observer with a set of differential equations as:

$$\{ \begin{matrix}ξ = {\dot{\hat{T}}}_{v} - N {T}_{s} \\ \dot{ξ} = ( {a}_{11} - N {a}_{21} ) ξ + ( {a}_{12} - N {a}_{22} + N {a}_{11} - {N}^{2} {a}_{21} ) {T}_{s} + {b}_{1} P \\ {\hat{T}}_{v} = ξ + {NT}_{s}\end{matrix}$$

where: a₁₁ . . . a₂₂ and b₁ are coefficients including at least one value from the parameter set; P is the thermal power delivered to the cooking vessel; Tₛ is the cook-surface temperature; \hat{T}ᵥ is the estimated vessel temperature; \dot{\hat{T}}ᵥ is an estimated rate of change of the vessel temperature; and N is a convergence rate.

The method of any preceding clause, wherein the temperature module comprises one of a state observer or a Kalman filter.

The method of any preceding clause, further comprising passing the cook-surface temperature to a low-pass filter to define a filtered cook-surface temperature.

The method of any preceding clause, further comprising passing the filtered cook-surface temperature to the temperature module for determining the estimated vessel temperature.

The method of any preceding clause, further comprising determining an error between the estimated vessel temperature and the temperature set point, and defining a requested power level for the induction coil based on the error.

The method of any preceding clause, further comprising: performing one or more data acquisition tests on a plurality of known cooking vessels; determining, for each known cooking vessel in the plurality of known cooking vessels, a set of known vessel parameters based on the one or more data acquisition tests; simulating operation of the controller module with each known cooking vessel in the plurality of known cooking vessels by using the temperature module with each set of known vessel parameters; and determining, based on the simulating, a single parameter set representative of all known cooking vessels in the plurality of known cooking vessels.

The method of any preceding clause, wherein the set of known cooking vessels does not include the cooking vessel.

An induction cooking appliance, comprising: a cook surface with a heating zone configured to receive a cooking vessel; an induction heating system comprising an induction coil and a power supply and configured to generate heat within the cooking vessel by electromagnetic induction; a temperature sensor coupled to the cook surface and configured to provide a signal indicative of a cook-surface temperature; a power sensor configured to provide a signal indicative of an electrical power delivered to the induction coil, with the electrical power corresponding to a thermal power delivered to the cooking vessel; a controller module coupled to the temperature sensor and the sensor, and operably coupled to the induction heating system, the controller module comprising a parameter set and a temperature module having a thermodynamic model of the cook surface, the cooking vessel, and ambient air; wherein the controller module is configured to: determine, via the temperature module, an estimated vessel temperature based on the thermodynamic model, the cook-surface temperature, and the thermal power; compare the estimated vessel temperature with a temperature set point for the induction cooking appliance; and controllably operate the induction cooking appliance based on the comparison.

The induction cooking appliance of any preceding clause, wherein the parameter set comprises at least one of a thermal exchange coefficient γᵥₛ representative of thermal exchange between the cooking vessel and the cook surface, a thermal exchange coefficient γᵥₐ representative of thermal exchange between the cooking vessel and ambient air present above and below the cook surface, a thermal capacity Cᵥ representative of the cooking vessel, a thermal capacity Cₛ representative of the cook surface, a convergence rate, or a power transfer efficiency.

The induction cooking appliance of any preceding clause, wherein the temperature module comprises a hidden-state observer with a set of differential equations as:

$$[ \begin{matrix}{\dot{\hat{T}}}_{v} \\ {\dot{\hat{T}}}_{s}\end{matrix} ] = [ \begin{matrix}{a}_{11} & {a}_{12} \\ {a}_{21} & {a}_{22}\end{matrix} ] [ \begin{matrix}{\hat{T}}_{v} \\ {\hat{T}}_{s}\end{matrix} ] + [ \begin{matrix}{b}_{11} & {b}_{12} & {b}_{13} \\ {b}_{21} & {b}_{22} & {b}_{23}\end{matrix} ] [ \begin{matrix}P \\ {T}_{s} \\ {\hat{T}}_{s}\end{matrix} ]$$

where: a₁₁ . . . a₂₂ and b₁₁ . . . b₂₃ are coefficients including at least one value from the parameter set; P is the thermal power delivered to the cooking vessel; Tₛ is the cook-surface temperature; \dot{T}ₛ is a measured rate of change for the cook-surface temperature; \dot{\hat{T}}ₛ is an estimated rate of change for the cook-surface temperature; \hat{T}ᵥ is the estimated vessel temperature; and \dot{\hat{T}}ᵥ is an estimated rate of change of the vessel temperature.

The induction cooking appliance of any preceding clause, wherein the temperature module comprises a hidden-state observer with a set of differential equations as:

$$[ \begin{matrix}{\dot{\hat{T}}}_{v} \\ {\dot{\hat{T}}}_{s} \\ {\dot{\hat{T}}}_{i n t}\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}{\hat{T}}_{v} \\ {\hat{T}}_{s} \\ {\hat{T}}_{i n t}\end{matrix} ] + [ \begin{matrix}{b}_{11} & {b}_{12} & {b}_{13} & {b}_{14} \\ {b}_{21} & {b}_{22} & {b}_{23} & {b}_{24} \\ {b}_{31} & {b}_{32} & {b}_{33} & {b}_{34}\end{matrix} ] [ \begin{matrix}P \\ {T}_{s} \\ {\dot{T}}_{s} \\ {\hat{T}}_{i n t}\end{matrix} ]$$

where: a₁₁ . . . a₃₃ and b₁₁ . . . b₃₄ are coefficients including at least one value from the parameter set; P is the thermal power delivered to the cooking vessel; \hat{T}ᵢₙₜ is an estimated temperature of the ambient air beneath the cook surface 12; \dot{\hat{T}}ᵢₙₜ is an estimated rate of change for the temperature of the ambient air beneath the cook surface 12; Tₛ is the cook-surface temperature; \hat{T}ₛ is an estimated cook-surface temperature based on signals from at least one of the temperature sensor or the power sensor; \dot{T}ₛ is a measured rate of change for the cook-surface temperature; \dot{\hat{T}}ₛ is an estimated rate of change for the cook-surface temperature; \hat{T}ᵥ is the estimated vessel temperature; and \dot{\hat{T}}ᵥ is an estimated rate of change of the vessel temperature.

The induction cooking appliance of any preceding clause, wherein the temperature module comprises a hidden-state observer with a set of differential equations as:

$$\{ \begin{matrix}ξ = {\dot{\hat{T}}}_{v} - N {T}_{s} \\ \dot{ξ} = ( {a}_{11} - N {a}_{21} ) ξ + ( {a}_{12} - N {a}_{22} + N {a}_{11} - {N}^{2} {a}_{21} ) {T}_{s} + {b}_{1} P \\ {\hat{T}}_{v} = ξ + {NT}_{s}\end{matrix}$$

where: a₁₁ . . . a₂₂ and b₁ are coefficients including at least one value from the parameter set; P is the thermal power delivered to the cooking vessel; Tₛ is the cook-surface temperature; \hat{T}ᵥ is the estimated vessel temperature; \dot{\hat{T}}ᵥ is an estimated rate of change of the vessel temperature; and N is a convergence rate.

The induction cooking appliance of any preceding clause, wherein the temperature module comprises one of a state observer or a Kalman filter.

The induction cooking appliance of any preceding clause, wherein the controller module further comprises a low-pass filter and a numerical differentiator for defining a filtered cook-surface temperature based on the signal from the temperature sensor.

The induction cooking appliance of any preceding clause, wherein the controller module further comprises a processor configured to determine an error between the estimated vessel temperature and the temperature set point, and to define a requested power level for the induction coil based on the error.

The induction cooking appliance of any preceding clause, wherein the temperature sensor is positioned centrally within the heating zone, and further comprising a second temperature sensor positioned within the heating zone.

What is claimed is:

1. A method of controlling an induction cooking appliance having a cook surface and an induction coil, and with a cooking vessel disposed on the cook surface, the method comprising:
sensing a cook-surface temperature during operation of the induction coil;
determining a thermal power delivered to the cooking vessel;
transmitting the cook-surface temperature and the thermal power to a controller module comprising a parameter set having one or more vessel parameters, and also comprising a temperature module having a thermodynamic model of the cook surface, the cooking vessel, and ambient air;
determining, by the temperature module, an estimated vessel temperature of the cooking vessel based on the thermodynamic model, the cook-surface temperature, and the thermal power;
comparing the estimated vessel temperature with a temperature set point for the cooking vessel; and
controllably operating the induction cooking appliance based on the comparison.

2. The method of claim 1, wherein the parameter set comprises at least one of a thermal exchange coefficient γᵥₛ representative of thermal exchange between the cooking vessel and the cook surface, a thermal exchange coefficient γᵥₐ representative of thermal exchange between the cooking vessel and ambient air present above and below the cook surface, a thermal capacity Cᵥ representative of the cooking vessel, a thermal capacity Cₛ representative of the cook surface, a convergence rate, or a power transfer efficiency.

3. The method of claim 2, wherein the temperature module comprises a hidden-state observer with a set of differential equations as:
$$[ \begin{matrix}{\dot{\hat{T}}}_{v} \\ {\dot{\hat{T}}}_{s}\end{matrix} ] = [ \begin{matrix}{a}_{11} & {a}_{12} \\ {a}_{21} & {a}_{22}\end{matrix} ] [ \begin{matrix}{\hat{T}}_{v} \\ {\hat{T}}_{s}\end{matrix} ] + [ \begin{matrix}{b}_{11} & {b}_{12} & {b}_{13} \\ {b}_{21} & {b}_{22} & {b}_{23}\end{matrix} ] [ \begin{matrix}P \\ {T}_{s} \\ {\dot{T}}_{s}\end{matrix} ]$$
where:
a₁₁ . . . a₂₂ and b₁₁ . . . b₂₃ are coefficients including at least one value from the parameter set;
P is the thermal power delivered to the cooking vessel;
Tₛ is the cook-surface temperature;
\dot{T}ₛ is a measured rate of change for the cook-surface temperature;
\dot{\hat{T}}ₛ is an estimated rate of change for the cook-surface temperature;
\hat{T}ᵥ is the estimated vessel temperature; and
\dot{\hat{T}}ᵥ is an estimated rate of change of the vessel temperature.

4. The method of claim 2, wherein the temperature module comprises a hidden-state observer with a set of differential equations as:
$$[ \begin{matrix}{\dot{\hat{T}}}_{v} \\ {\dot{\hat{T}}}_{s} \\ {\dot{\hat{T}}}_{i n t}\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}{\hat{T}}_{v} \\ {\hat{T}}_{s} \\ {\hat{T}}_{i n t}\end{matrix} ] + [ \begin{matrix}{b}_{11} & {b}_{12} & {b}_{13} & {b}_{14} \\ {b}_{21} & {b}_{22} & {b}_{23} & {b}_{24} \\ {b}_{31} & {b}_{32} & {b}_{33} & {b}_{34}\end{matrix} ] [ \begin{matrix}P \\ {T}_{s} \\ {\dot{T}}_{s} \\ {\hat{T}}_{i n t}\end{matrix} ]$$
where:
a₁₁ . . . a₃₃ and b₁₁ . . . b₃₄ are coefficients including at least one value from the parameter set;
P is the thermal power delivered to the cooking vessel;
\hat{T}ᵢₙₜ is an estimated temperature of ambient air beneath the cook surface;
\dot{\hat{T}}ᵢₙₜ is an estimated rate of change for the temperature of the ambient air beneath the cook surface;
Tₛ is the cook-surface temperature;
\hat{T}ₛ is an estimated cook-surface temperature based on signals from at least one of a temperature sensor or a power sensor;
\dot{T}ₛ is a measured rate of change for the cook-surface temperature;
\dot{\hat{T}}ₛ is an estimated rate of change for the cook-surface temperature;
\hat{T}ᵥ is the estimated vessel temperature; and
\dot{\hat{T}}ᵥ is an estimated rate of change of the vessel temperature.

5. The method of claim 2, wherein the temperature module comprises a hidden-state observer with a set of differential equations as:
$$\{ \begin{matrix}ξ = {\dot{\hat{T}}}_{v} - N {T}_{s} \\ \dot{ξ} = ( a {11}_{} - N {a}_{21} ) ξ + ( a {12}_{} - N {a}_{22} + N {a}_{11} - {N}^{2} {a}_{21} ) {T}_{s} + {b}_{1} P \\ {\hat{T}}_{v} = ξ + {NT}_{s}\end{matrix}$$
where:
a₁₁ . . . a₂₂ and b₁ are coefficients including at least one value from the parameter set;
P is the thermal power delivered to the cooking vessel;
Tₛ is the cook-surface temperature;
\hat{T}ᵥ is the estimated vessel temperature;
\dot{\hat{T}}ᵥ is an estimated rate of change of the vessel temperature; and
N is a convergence rate.

6. The method of claim 1, wherein the temperature module comprises one of a state observer or a Kalman filter.

7. The method of claim 1, further comprising passing the cook-surface temperature to a low-pass filter to define a filtered cook-surface temperature.

8. The method of claim 7, further comprising passing the filtered cook-surface temperature to the temperature module for determining the estimated vessel temperature.

9. The method of claim 1, further comprising determining an error between the estimated vessel temperature and the temperature set point, and defining a requested power level for the induction coil based on the error.

10. The method of claim 1, further comprising:
performing one or more data acquisition tests on a plurality of known cooking vessels;
determining, for each known cooking vessel in the plurality of known cooking vessels, a set of known vessel parameters based on the one or more data acquisition tests;
simulating operation of the controller module with each known cooking vessel in the plurality of known cooking vessels by using the temperature module with each set of known vessel parameters; and
determining, based on the simulating, a single parameter set representative of all known cooking vessels in the plurality of known cooking vessels.

11. The method of claim 10, wherein the set of known cooking vessels does not include the cooking vessel.

12. An induction cooking appliance, comprising:
a cook surface with a heating zone configured to receive a cooking vessel;
an induction heating system comprising an induction coil and a power supply and configured to generate heat within the cooking vessel by electromagnetic induction;
a temperature sensor coupled to the cook surface and configured to provide a signal indicative of a cook-surface temperature;
a power sensor configured to provide a signal indicative of an electrical power delivered to the induction coil, with the electrical power corresponding to a thermal power delivered to the cooking vessel;
a controller module coupled to the temperature sensor and the sensor, and operably coupled to the induction heating system, the controller module comprising a parameter set and a temperature module having a thermodynamic model of the cook surface, the cooking vessel, and ambient air;
wherein the controller module is configured to:
determine, via the temperature module, an estimated vessel temperature based on the thermodynamic model, the cook-surface temperature, and the thermal power;
compare the estimated vessel temperature with a temperature set point for the induction cooking appliance; and
controllably operate the induction cooking appliance based on the comparison.

13. The induction cooking appliance of claim 12, wherein the parameter set comprises at least one of a thermal exchange coefficient γᵥₛ representative of thermal exchange between the cooking vessel and the cook surface, a thermal exchange coefficient γᵥₐ representative of thermal exchange between the cooking vessel and ambient air present above and below the cook surface, a thermal capacity Cᵥ representative of the cooking vessel, a thermal capacity Cₛ representative of the cook surface, a convergence rate, or a power transfer efficiency.

14. The induction cooking appliance of claim 13, wherein the temperature module comprises a hidden-state observer with a set of differential equations as:
$$[ \begin{matrix}{\dot{\hat{T}}}_{v} \\ {\dot{\hat{T}}}_{s}\end{matrix} ] = [ \begin{matrix}{a}_{11} & {a}_{12} \\ {a}_{21} & {a}_{22}\end{matrix} ] [ \begin{matrix}{\hat{T}}_{v} \\ {\hat{T}}_{s}\end{matrix} ] + [ \begin{matrix}{b}_{11} & {b}_{12} & {b}_{13} \\ {b}_{21} & {b}_{22} & {b}_{23}\end{matrix} ] [ \begin{matrix}P \\ {T}_{s} \\ {\dot{T}}_{s}\end{matrix} ]$$
where:
a₁₁ . . . a₂₂ and b₁₁ . . . b₂₃ are coefficients including at least one value from the parameter set;
P is the thermal power delivered to the cooking vessel;
Tₛ is the cook-surface temperature;
\dot{T}ₛ is a measured rate of change for the cook-surface temperature;
\hat{\dot{T}}ₛ is an estimated rate of change for the cook-surface temperature;
\hat{T}ᵥ is the estimated vessel temperature; and
\dot{\hat{T}}ᵥ is an estimated rate of change of the vessel temperature.

15. The induction cooking appliance of claim 13, wherein the temperature module comprises a hidden-state observer with a set of differential equations as:
$$[ \begin{matrix}{\dot{\hat{T}}}_{v} \\ {\dot{\hat{T}}}_{s} \\ {\dot{\hat{T}}}_{i n t}\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}{\hat{T}}_{v} \\ {\hat{T}}_{s} \\ {\hat{T}}_{i n t}\end{matrix} ] + [ \begin{matrix}{b}_{11} & {b}_{12} & {b}_{13} & {b}_{14} \\ {b}_{21} & {b}_{22} & {b}_{23} & {b}_{24} \\ {b}_{31} & {b}_{32} & {b}_{33} & {b}_{34}\end{matrix} ] [ \begin{matrix}P \\ {T}_{s} \\ {\dot{T}}_{s} \\ {\hat{T}}_{i n t}\end{matrix} ]$$
where:
a₁₁ . . . a₃₃ and b₁₁ . . . b₃₄ are coefficients including at least one value from the parameter set;
P is the thermal power delivered to the cooking vessel;
\hat{T}ᵢₙₜ is an estimated temperature of ambient air beneath the cook surface;
\dot{\hat{T}}ᵢₙₜ is an estimated rate of change for the temperature of the ambient air beneath the cook surface;
Tₛ is the cook-surface temperature;
\hat{T}ₛ is an estimated cook-surface temperature based on signals from at least one of the temperature sensor or the power sensor;
\dot{T}ₛ is a measured rate of change for the cook-surface temperature;
\dot{\hat{T}}ₛ is an estimated rate of change for the cook-surface temperature;
\hat{T}ᵥ is the estimated vessel temperature; and
\dot{\hat{T}}ᵥ is an estimated rate of change of the vessel temperature.

16. The induction cooking appliance of claim 13, wherein the temperature module comprises a hidden-state observer with a set of differential equations as:
$$\{ \begin{matrix}ξ = {\dot{\hat{T}}}_{v} - N {T}_{s} \\ \dot{ξ} = ( a {11}_{} - N {a}_{21} ) ξ + ( a {12}_{} - N {a}_{22} + N {a}_{11} - {N}^{2} {a}_{21} ) {T}_{s} + {b}_{1} P \\ {\hat{T}}_{v} = ξ + {NT}_{s}\end{matrix}$$
where:
a₁₁ . . . a₂₂ and b₁ are coefficients including at least one value from the parameter set;
P is the thermal power delivered to the cooking vessel;
Tₛ is the cook-surface temperature;
\hat{T}ᵥ is the estimated vessel temperature;
\dot{\hat{T}}ᵥ is an estimated rate of change of the vessel temperature; and
N is a convergence rate.

17. The induction cooking appliance of claim 12, wherein the temperature module comprises one of a state observer or a Kalman filter.

18. The induction cooking appliance of claim 12, wherein the controller module further comprises a low-pass filter and a numerical differentiator for defining a filtered cook-surface temperature based on the signal from the temperature sensor.

19. The induction cooking appliance of claim 12, wherein the controller module further comprises a processor configured to determine an error between the estimated vessel temperature and the temperature set point, and to define a requested power level for the induction coil based on the error.

20. The induction cooking appliance of claim 12, wherein the temperature sensor is positioned centrally within the heating zone, and further comprising a second temperature sensor positioned within the heating zone.
